(19) United States
(12) Patent Application Publication
(10) Pub. No.: US 2002/0054829 A1
(43) Pub. Date: May 9, 2002

(54) Apparatus for treating objects

(75) Inventors: Charilaos Dalkidis, Schwetzingen (DE); Peter Scheck, Rauenberg (DE); Stefan Thiem, Heidelberg (DE)

Correspondence Address: Simpson, Simpson & Snyder, PLLC, 5555 Main Street, Williamsville, NY, 14221, US

(73) Assignee: Leica Microsystems Nussloch GmbH, Nussloch (DE)

(21) Appl. No.: 09/933,415

(22) Filed: Aug. 20, 2001

(30) Foreign Application Priority Data
Aug. 22, 2000 (DE) 100 41 229.7

(51) Int. Cl. G01N 35/04

(52) U.S. Cl. 422/63; 422/65; 422/100

(57) ABSTRACT

An apparatus for treating objects, in particular cytological or histological specimens, having multiple processing stations (3) arranged in a housing (2) and having a transport device (5) for delivering the objects, or the object carriers (4) carrying the objects, into and out of the processing stations (3), is characterized by a region, coordinated with the processing stations (3), for the reception of modular treatment stations (10) having permanently definable functions.

### CROSS REFERENCE TO RELATED APPLICATIONS

This invention claims priority of the German patent application 100 41 229.7 filed Aug. 22, 2000 which is incorporated by reference herein.

### FIELD OF THE INVENTION

The invention concerns an apparatus for treating objects, in particular cytological or histological specimens, having multiple processing stations arranged in a housing and having a transport device for delivering the objects, or the object carriers carrying the objects, into and out of the processing stations.

### BACKGROUND OF THE INVENTION

The reader is referred, purely by way of example, to EP 0 849 582 A2. This document discloses a generic apparatus for treating objects, in particular cytological or histological specimens. In this, cytological or histological specimens are conveyed by way of an object carrier or basket to an automatic stainer, the automatic stainer comprising multiple processing stations.

The generic apparatus known from EP 0 849 582 A2 comprises different processing stations having containers allocated to said processing stations, so that different treatments of the respective specimen can take place in each of the processing stations depending on the liquid contained in the container. Each of the processing stations is configured or designed like the others, so that with the known apparatus, only standardized process steps can be performed.

### SUMMARY OF THE INVENTION

It is the object of the present invention to configure and further develop an apparatus for treating objects, in particular cytological or histological specimens, so as to yield the greatest possible flexibility in terms of the process steps that can be performed.

The aforesaid object is achieved by the features of the present invention. According to this, a generic apparatus for treating objects, in particular cytological and histological specimens, is characterized by a region, coordinated with the processing stations, for the reception of modular treatment stations having permanently definable functions.

What has been recognized according to the present invention is that, proceeding from a standardized equipment set of a generic apparatus, it is possible to achieve a substantially higher level of flexibility in processing if further (modular) processing stations having permanently defined functions or special functions are provided. For that purpose, a very particular region for reception of the modular treatment stations, which is coordinated with the actual processing stations, is provided. The apparatus can consequently have modular treatment stations added to it in such a way that further functions can be integrated, without thereby needing to intervene in the arrangement defined by the processing stations.

Concretely, at least two combined reception and connection regions for reception of the modular treatment stations could be provided, so that the modular treatment stations—for example, two next to one another—can be inserted into the reception region and connected there in order to implement their functionality.

The reception and connection regions could comprise a bar for reception and insertion of the modular treatment station. In addition, a docking point for connection of the supply system and (if applicable) disposal system of the modular treatment stations could be provided there (in the end region of the bar). Concretely, the modular treatment station could have plug-like connector stems and electrical contacts that correspond to corresponding openings and contacts of the docking point. In the docked state, i.e. when the connector stems are inserted and the electrical contacts are closed, a connection that is electrically conductive and/or thermally conductive and/or carries a flow medium is created between the modular treatment station and the apparatus. In other words, the reception and connection region on the one hand and the modular treatment station on the other hand can be configured in such a way that connection is accomplished upon insertion of the modular treatment station, with no need for further actions. Easy exchange of the modular treatment station is possible, the arrangement of the plug-like connector stems and of the electrical contacts being defined for the exchange of modular treatment stations as desired.

The region for reception of the modular treatment stations could be configured alongside and/or at least slightly below the actual treatment stations, so that the modular treatment stations can be arranged in the immediate vicinity of the processing station and can be reached and loaded over the shortest possible distances.

Insertion or exchange of the modular treatment stations could be accomplished via a cover covering the actual processing stations; connection in this context proves difficult. Advantageously, a separate access opening, which can be closed off by a cover, a hood, or the like, is provided in the housing for insertion and exchange of the modular treatment stations. The access opening could be configured on the back side or back wall of the housing, preferably in a lateral region, so that the modular treatment station can be inserted from the back- side of the housing into its working position, and there can optionally be snap-locked in. The connection is effected upon insertion of the modular treatment station, so that further assembly work is not necessary.

The modular treatment station can be any treatment station having different functions. For the reception of liquids serving for treatment and for the reception (in the liquid) of the object carrier, the modular treatment station comprises a container adapted in terms of shape and size to the object carrier.

The modular treatment station differs from the other processing stations in that particular function groups or functions are permanently defined. For that purpose, the modular treatment station could comprise a heating station. The provision of a rinsing device could also be advantageous, specifically if the object to be treated must be rinsed. Also advantageous is a turbulence-inducing device for the liquid used for treatment, specifically in order, for example, to prevent sedimentation or demixing in the liquid. In addition, a device of this kind allows flow to occur around the object being treated, thereby enhancing the action of the respective reagents.

In the context of a further advantageous embodiment, the modular treatment station comprises a fan or an air extraction system or an extraction system for vapors. Extraction could be accomplished via an extraction chamber, the extraction chamber being, in additionally advantageous fashion, flow-connected to a central extraction system. Aggressive vapors can thus be discharged without difficulty and cannot exert a negative influence in the region of the other processing stations.

In additionally advantageous fashion, the modular treatment station comprises a control system or optionally a closed-loop control system for the various functional units, the respective functions being defined, for example, by way of a program unit.

As already mentioned earlier, the modular treatment station comprises a vessel, a chamber delimited therein possibly serving to receive the object carriers. Particular holding means can be provided on the one hand to receive and on the other hand to secure the object carriers, thus making possible retention or clamping of the object carrier.

Lastly, let it be noted that the transport device also serves, inter alia, to deliver the objects, or the object carriers carrying the objects, into the modular treatment station. For that purpose, the transport device is advantageously equipped with a robot arm that in turn advantageously comprises two partial arms that are rotatable about a vertical shaft and adjustable in height on the vertical shaft.

### BRIEF DESCRIPTION OF THE DRAWINGS

There are various ways of advantageously embodying and developing the of the present invention. The reader is referred, for that purpose, on the one hand to the claims subordinate to claim 1, and on the other hand to the explanation below of an exemplary embodiment of the invention with reference to the drawings. In conjunction with the explanation of a preferred exemplary embodiment of the invention with reference to the drawings, an explanation is also given of generally preferred embodiments and developments of the teaching. In the drawings:

FIG. 1 schematically depicts an open automatic stainer as exemplary embodiment of an apparatus according to the present invention;

FIG. 2 shows the subject matter of FIG. 1 in a lateral rear view, with the access opening closed;

FIG. 3 shows the subject matter of FIG. 1 in a rear view with the access opening open, only one modular treatment station being inserted;

FIG. 4 shows the subject matter of FIG. 3 in a complete rear view, only one modular treatment station being inserted;

FIG. 5 shows an exemplary embodiment of a modular treatment station from the connection side; and

FIG. 6 shows the subject matter of FIG. 5 from the rear.

### DETAILED DESCRIPTION OF THE INVENTION

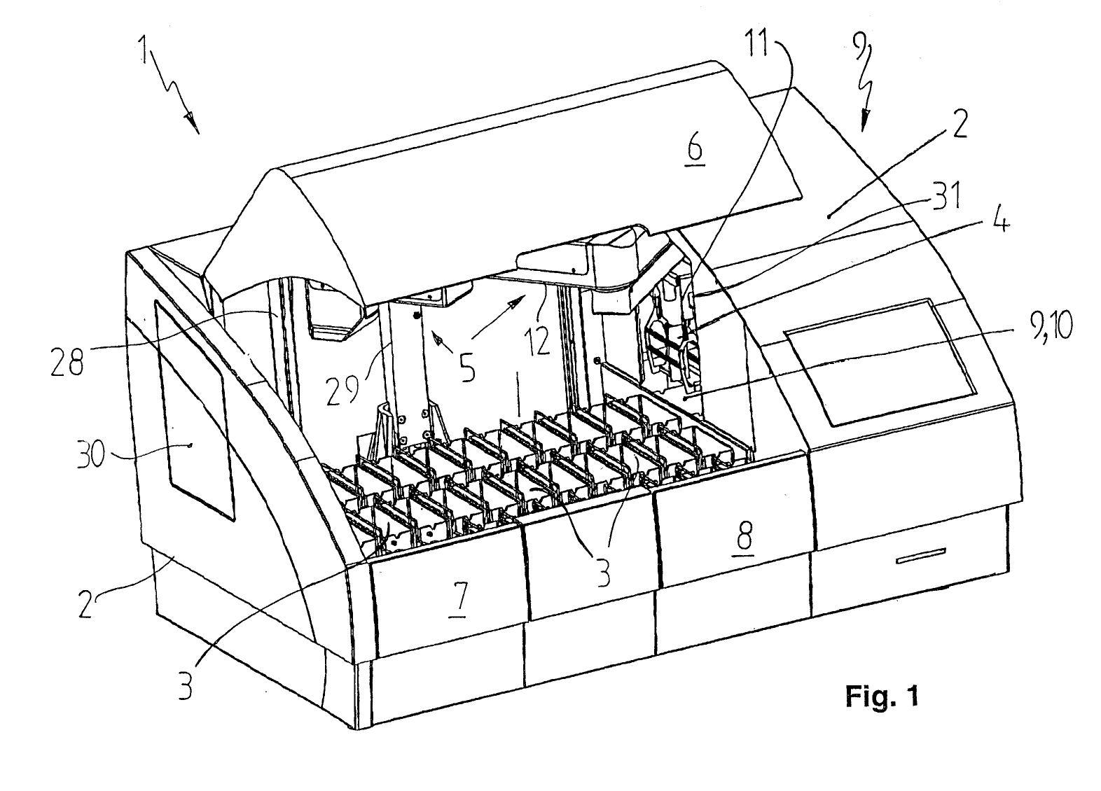

FIG. 1 shows, in a schematic view, an automatic stainer 1 as exemplary embodiment of an apparatus according to the present invention for treating objects (not shown in the Figure), these being in particular cytological or histological specimens. The apparatus or automatic stainer 1 comprises a housing 2 and processing stations 3 arranged in housing 2, these being configured as vessels for the reception of object carriers 4 carrying the objects.

Also evident from FIG. 1 is the provision of a transport device 5, the latter serving to deliver the objects, or object carriers 4 carrying the objects, into and out of processing stations 3 or the vessels. Cover 6 which serves to cover automatic stainer 1 is so that automatic stainer 1 can be looked into. Drawers 7, 8 for loading automatic stainer 1 and for the removal of the treated objects, or object carriers 4 carrying the treated objects, are indicated in the closed state.

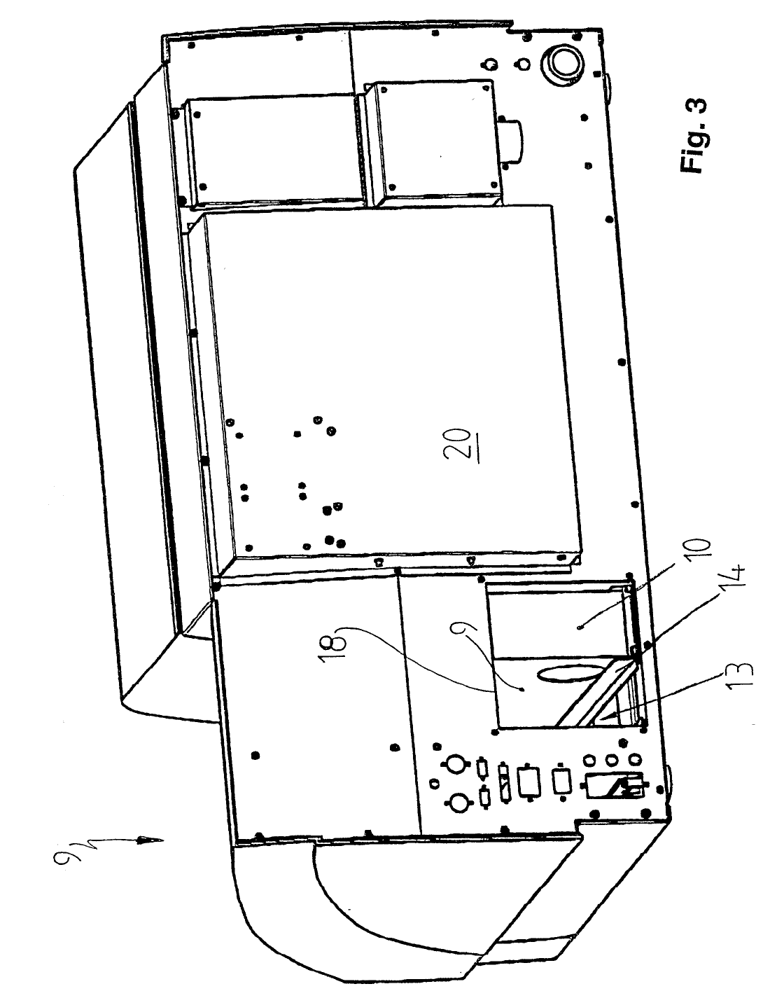

According to the present invention, a region 9 coordinated with processing stations 3, which serves for the reception of modular treatment stations 10 having permanently defined functions, is provided. Modular treatment stations 10 are evident in particular from FIGS. 3 through 6, their provision in FIG. 1 being indicated only in the region of gripper 11 of transport device 5 that is pivoted in at that point, and of robot arm 12 belonging to transport device 5.

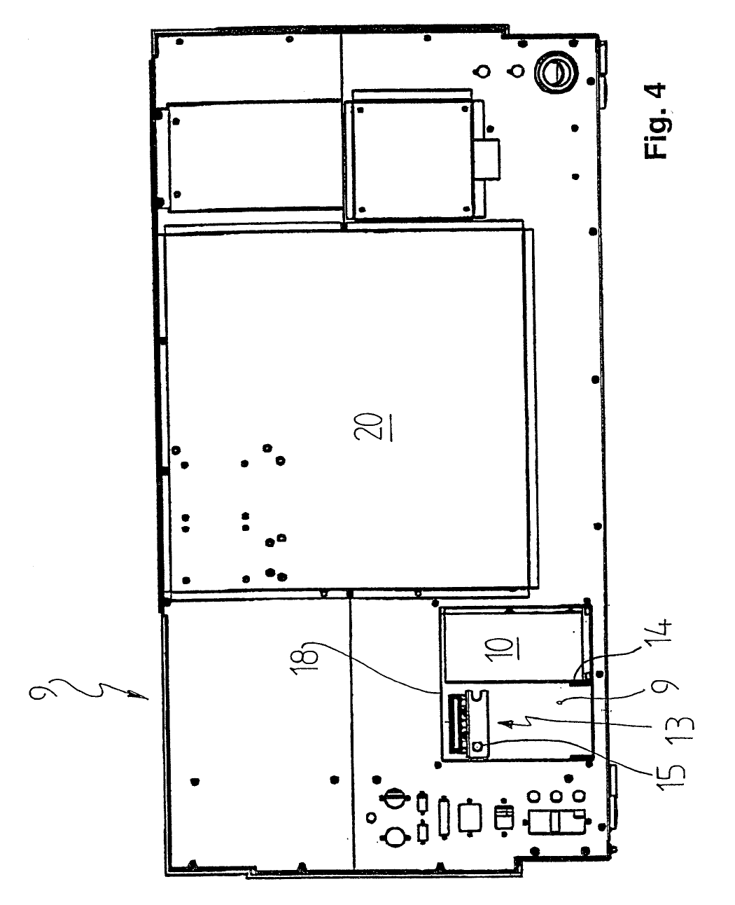

In the exemplary embodiment of an automatic stainer 1 according to the present invention shown in FIGS. 1 through 4, two combined reception and connection regions 13 for the reception of modular treatment stations 10 are provided, reception and connection regions 13 having a bar 14 for the reception and insertion of modular treatment stations 10. Reference is made, in this context, to the illustration in FIG. 3. It is evident from FIG. 4 that reception/connection region 13 has a docking point 15 for connecting the supply system of modular treatment station 10, modular treatment station 10 comprising plug-like connector stems 16 and electrical contacts 17 that correspond to corresponding openings and contacts of docking point 15. Contact or docking is attained upon insertion of modular treatment station 10, on bar 14, into reception/connection region 13. Modular treatment station 10 can easily be removed in the reverse order.

It is evident from FIGS. 3 and 4 that therein, one modular treatment station 10 is inserted on bar 14. In the docked state, i.e. when connector stems 16 are plugged in and electrical contacts 17 are closed, a connection that is electrically conductive, thermally conductive, and/or carries a flow medium is created between modular treatment station 10 and docking point 15 of automatic stainer 1.

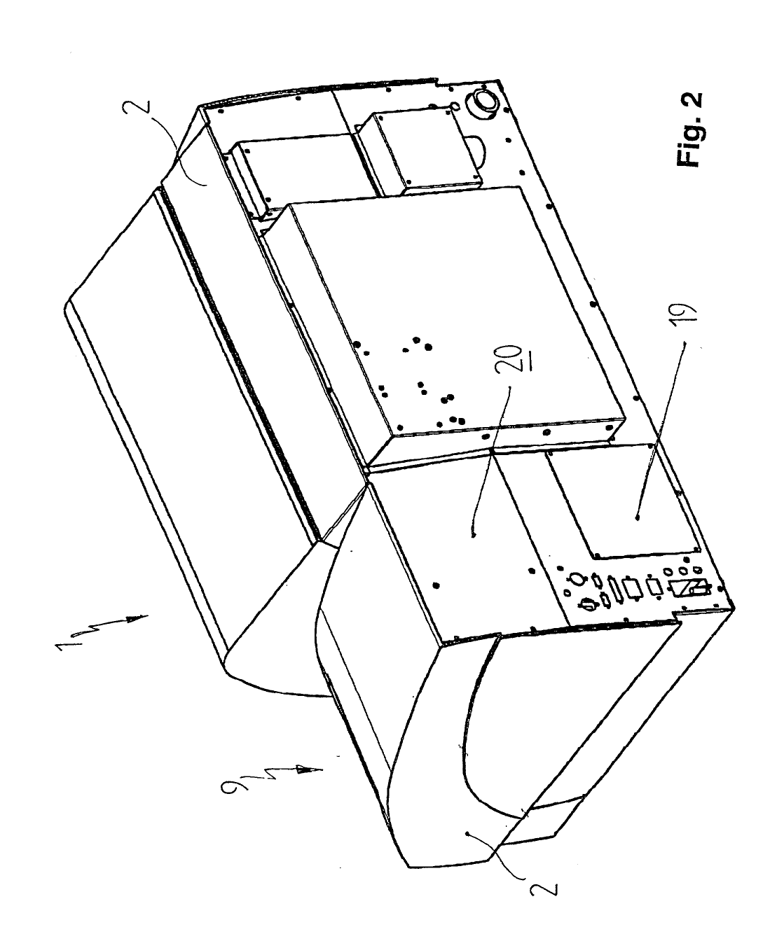

FIGS. 1 and 4 all show that region 9 for the reception of modular treatment stations 10 is configured alongside and slightly below the actual processing stations 3 or vessels therein. An access opening 18, which in the depiction selected in FIG. 2 is closed off by a cover 19, is provided in housing 2 of automatic stainer 2 for the insertion or exchange of modular treatment stations 10. The illustrations of FIGS. 3 and 4 show access opening 18 with cover 19 removed, so that an inserted modular treatment station 10 and an empty region 9 for a further (not yet inserted) modular treatment station 10 are visible.

FIGS. 2, 3, and 4 indicate that access opening 18 is configured on back wall 20 of the housing and in a lateral region thereon. Other arrangements are conceivable, regions directly alongside the actual processing stations 3 always being appropriate.

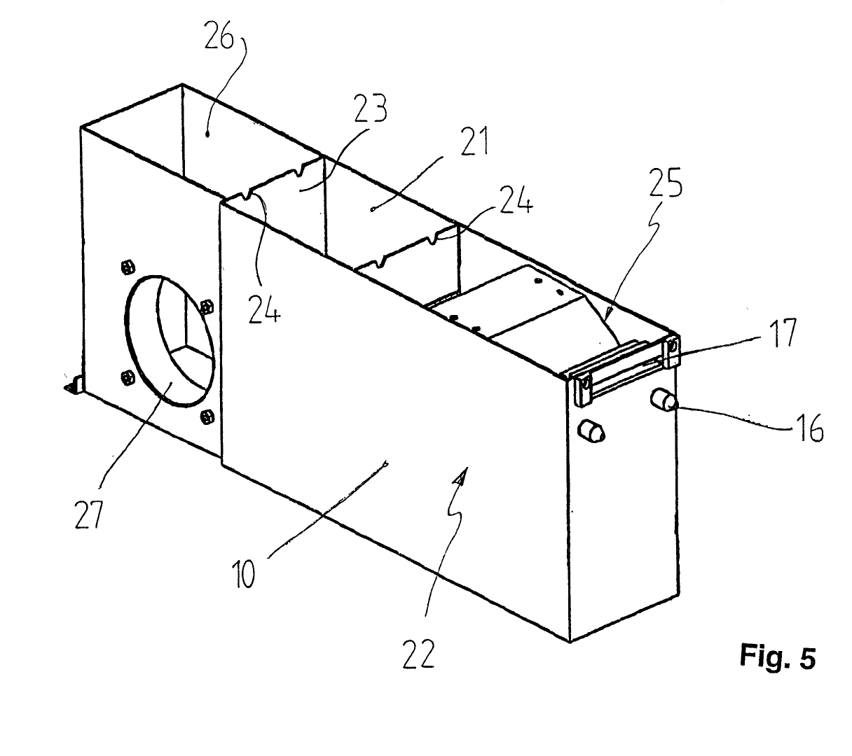

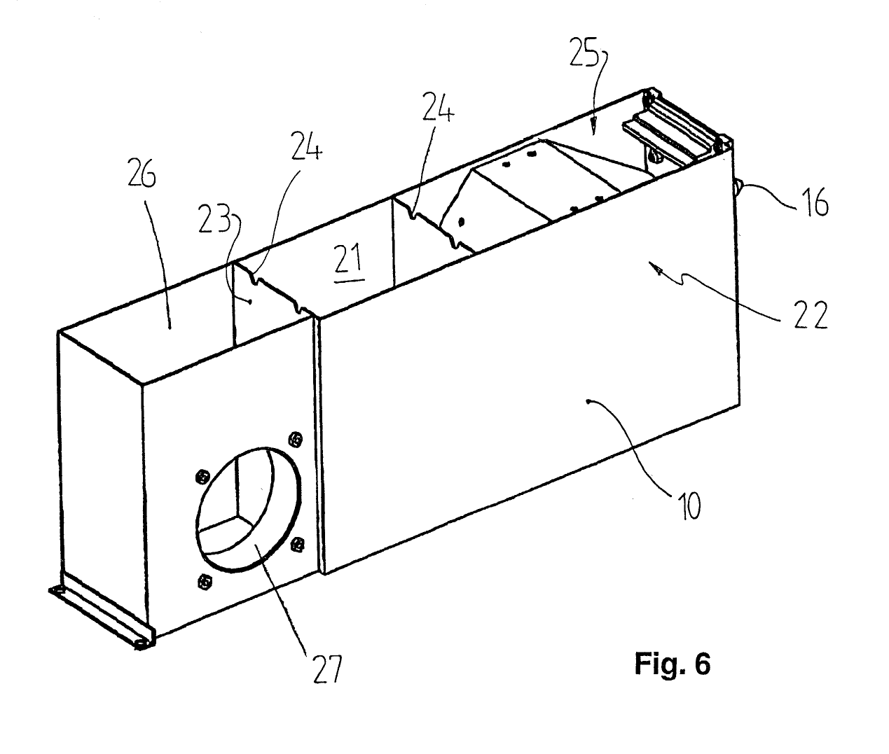

FIGS. 5 and 6 show an exemplary embodiment of a modular treatment station 10 that is configured analogously to a treatment station 3 and a vessel provided therein. Concretely, modular treatment station 10 comprises a container 21 for the reception of liquid used for treatment and of object carrier 4 (which is not depicted in FIGS. 5 and 6).

Modular treatment station 10 shown here furthermore comprises a heating station 22 with a corresponding heating device, the heating station serving to heat reagents or the like.

Container 21 configured in modular treatment station 10 has, on its partition walls 23, notches 24 that serve to secure and immobilize object carrier 4. Inside container 21, the liquid present therein is heated so that it can act in the heated state on the objects or specimens held by the object carriers. The necessary units such as heating system 22, fan, controller, and the like are arranged inside a further chamber 25, this being merely indicated here by reference character 22. Chamber 25 is preferably embodied in encapsulated fashion.

A further chamber 26 serves to extract the vapors that occur upon treatment of the objects or specimens, and for that purpose is equipped with a fan 27. This fan 27 forces the vapors behind the actual processing stations 3 toward a central extraction system 28, integrated into automatic stainer 1, that is indicated in FIG. 1. From there the vapors pass to an activated carbon filter (not shown in the Figures), and are purified as they flow through the activated carbon filter.

With reference to FIG. 1, let it be noted that transport device 5 serves to deliver the objects, or object carriers 4 carrying the objects, into modular treatment stations 10. Transport device 5 encompasses a robot arm 12 that in turn comprises two partial arms. Robot arm 12 is articulated rotatably on a vertical shaft 29, and is adjustable in height on vertical shaft 29. Gripper 11, which can move within automatic stainer 1 for unrestricted positioning of object carriers 4, is arranged at the free end of the one partial arm.

It is evident from FIG. 1 that robot arm 12 with gripper 11 can reach through lateral openings 30, 31, specifically on the one hand to pick up from other devices object carriers that are carrying objects or to transfer object carriers with treated objects, and on the other hand to transfer to the modular treatment stations object carriers that are carrying objects, and to return objects treated therein back into the region of the actual processing stations.

In conclusion, let it be emphasized very particularly that the exemplary embodiment discussed above serves for exemplary discussion of the teaching claimed, but does not limit it to the exemplary embodiment.

PARTS LIST

1 Automatic stainer

2 Housing

3 Processing station, vessel

4 Object carrier

5 Transport device

6 Cover (of housing)

7 Drawer (reception station)

8 Drawer (removal station)

9 Region (for modular treatment station)

10 Modular treatment station

11 Gripper

12 Robot arm

13 Reception/connection region

14 Bar

15 Docking point

16 Connector stem

17 Electrical contact

18 Access opening

19 Cover (of access opening)

20 Back wall (of housing)

21 Container (in modular treatment station)

22 Heating station

23 Partition wall

24 Notch

25 Chamber (for equipment)

26 Chamber (for ventilation)

27 Fan

28 Extraction system (in housing)

29 Vertical shaft

30 Opening (left)

31 Opening (right)

What is claimed is:

1. In an apparatus for treating cytological or histological specimens, said apparatus having multiple processing stations arranged in a housing and having a transport device for delivering said specimens, or object carriers carrying said specimens, into and out of said processing stations, the improvement comprising:
a modular treatment station having permanently definable functions; and
a region, coordinated with said processing stations, for receiving said modular treatment station.

2. The improvement as defined in claim 1, wherein said region comprises at least two combined reception and connection regions each for receiving a corresponding modular treatment station.

3. The improvement as defined in claim 2, wherein said modular treatment station comprises a supply system.

4. The improvement as defined in claim 3, wherein said modular treatment station further comprises a disposal system.

5. The improvement as defined in claim 3, wherein said combined reception and connection regions comprise a bar for reception and insertion of said modular treatment station, and a docking point for connection of said supply system.

6. The improvement as defined in claim 4, wherein said combined reception and connection regions comprise a bar for reception and insertion of said modular treatment-station, and a docking point for connection of said supply system and said disposal system.

7. The improvement as defined in claim 5, wherein said modular treatment station has plug-like connector stems and electrical contacts that correspond to corresponding openings and contacts of said docking point.

8. The improvement as defined in claim 7, wherein a connection that is electrically conductive is created between said modular treatment station and said apparatus when said modular treatment station is in a docked state.

9. The improvement as defined in claim 7, wherein a connection that is thermally conductive is created between said modular treatment station and said apparatus when said modular treatment station is in a docked state.

10. The improvement as defined in claim 7, wherein a connection that carries a flow medium is created between said modular treatment station and said apparatus when said modular treatment station is in a docked state.

11. The improvement as defined in claim 1, wherein said region for receiving said modular treatment station is configured alongside said multiple processing stations.

12. The improvement as defined in claim 1, wherein said region for receiving said modular treatment station is configured at least slightly below said multiple processing stations.

13. The improvement as defined in claim 1, wherein an access opening is provided in said housing for insertion and removal of said modular treatment station.

14. The improvement as defined in claim 13, further comprising a cover for closing said access opening.

15. The improvement as defined in claim 13, wherein said housing includes a back wall and said access opening is provided through said back wall.

16. The improvement as defined in claim 15, wherein said access opening is provided through a lateral portion of said back wall.

17. The improvement as defined in claim 1, wherein said modular treatment station comprises a container for receiving liquid used for treatment of said specimens.

18. The improvement as defined in claim 17, wherein said modular treatment station comprises a heating station.

19. The improvement as defined in claim 17, wherein said modular treatment station comprises a rinsing device.

20. The improvement as defined in claim 17, wherein said modular treatment station comprises a turbulence-inducing device for said liquid used for treatment.

21. The improvement as defined in claim 17, wherein said modular treatment station comprises a fan.

22. The improvement as defined in claim 17, wherein said modular treatment station comprises an extraction system for extracting vapors.

23. The improvement as defined in claim 22, wherein said extraction system includes an extraction chamber.

24. The improvement as defined in claim 23, wherein said apparatus has a central extraction system for extracting vapors, and said extraction chamber of said modular treatment station is in flow communication with said central extraction system.

25. The improvement as defined in claim 17, wherein said modular treatment station comprises a control system for various functional units.

26. The improvement as defined in claim 25, wherein said control system is a closed-loop control system.

27. The improvement as defined in claim 17, wherein said chamber also receives said object carriers.

28. The improvement as defined in claim 27, wherein said chamber includes holding means to receive and secure said object carriers.

29. The improvement as defined in claim 1, wherein said transport device serves to deliver said specimens, or said object carriers carrying said specimens, into said modular treatment stations.

30. The improvement as defined in claim 29, wherein said transport device is embodied as a robot arm.

31. The improvement as defined in claim 30, wherein said robot arm has two partial arms.

32. The improvement as defined in claim 30, wherein said robot arm is rotatable about a vertical shaft.

33. The improvement as defined in claim 30, wherein said robot arm is adjustable in height.
